(19) United States
(12) Patent Application Publication
(10) Pub. No.: US 2012/0330871 A1
(43) Pub. Date: Dec. 27, 2012

(54) USING VALUES OF PRPD ENVELOPE TO CLASSIFY SINGLE AND MULTIPLE PARTIAL DISCHARGE (PD) DEFECTS IN HV EQUIPMENT

(76) Inventor: Yahya Ahmed ASIRI, Dammam (SA)

(21) Appl. No.: 13/469,401

(22) Filed: May 11, 2012

Related U.S. Application Data
(60) Provisional application No. 61/501,518, filed on Jun. 27, 2011.

(51) Int. Cl. G06N 3/02; G06N 3/08

(52) U.S. Cl. 706/25; 706/15

(57) ABSTRACT

A method, system and computer program product for classifying types of partial discharge experienced by high voltage motors, reducing the labor and expertise required for such classification. This method, system and computer program product utilize feature extraction techniques to preprocess partial discharge measurements data to suit neural network input requirements.

### RELATED APPLICATION

This application claims priority to U.S. Provisional Patent Application No. 61/501,518 filed on Jun. 27, 2011, which is incorporated herein by reference.

### FIELD OF THE INVENTION

This invention relates to a method, system and computer program product for the classification of types of partial discharge experienced by high voltage motors, reducing the labor and expertise required for such classification.

### BACKGROUND OF THE INVENTION

Electric motors play a pivotal role in various industrial plant processes for electrical to mechanical energy conversion. As a result, their reliability and availability is of utmost importance to industries. Motors are generally robust and dependable, but they do experience wear with age, and occasionally newer motors may fail due to design deficiencies, incorrect operating conditions or improper installation.

Motor failure can be caused by mechanical faults such as broken rotor bars, broken end rings, damaged motor bearings or air-gap eccentricities, or can be caused by electrical faults such as stator-winding shorts or supply voltage imbalance. EPRI and IEEE surveys of motor failures have attributed 37% to stator faults, 10% to rotor faults, and 41-50% to bearing vibrations, with a small percentage due to other causes.

While fractional and small horsepower motors are relatively inexpensive off-the-shelf items, medium-voltage and high-voltage motors can be very expensive, with a long-lead time for obtaining a replacement. For such higher voltage motors, it is important to be able to detect and diagnose problems, in order to prevent catastrophic failures. In addition, the ability to accurately detect and diagnose problems can also allow an operator to avoid costs and downtime associated with prematurely taking a motor out of service for maintenance or replacement.

Motor manufacturers offer a variety of sensors for monitoring voltage, current, winding temperature, bearing temperature and bearing vibration. IEEE statistics indicate that up to 90% of the failures of high voltage electrical motors and generators are caused by a breakdown of the insulation system. Insulation is essential to preventing short circuits between the conductors or between a conductor and ground, causing the current to flow in undesired paths and preventing the proper operation of the motor. The insulation system also holds the copper conductors tightly in place, preventing undesired movement caused by electromagnetic forces. The life of a stator winding is limited most often by the electrical insulation rather than by the conductors or the steel core. Thus, it is especially critical to monitor the health of the stator winding insulation of high voltage motors.

Partial discharge (“PD”) is one cause of high voltage insulation failure. PD is an electrical discharge that creates carbonization and tracking that partially bridges insulation, providing a path for current to flow through insulation that is supposed to provide a barrier between one phase and another, or between a phase and ground. Thus, PD contrasts with a full discharge, which is a complete fault between line potential and ground, or between two phases. Partial discharges typically occur in gas-filled voids that are found in all winding insulation systems. The voids can be located: between the copper conductor and insulation wall; internal to the insulation itself; between the outer insulation wall and the grounded frame; or along the surface of the insulation. PD can occur because of the deterioration of insulation with age and/or because of premature aging due to overtemperatures.

Because PD involves a flow of electrons and ions across a small distance in a finite period of time, a small current flows every time a PD occurs. The current flow creates a voltage pulse across the impedance of the insulation system. The PD discharge pulses occur at high frequencies; therefore, they attenuate quickly as they pass through a short distance. This pulse can be recognized, measured and recorded, allowing for high voltage equipment to be monitored for PD during normal operation. At least one motor manufacturer offers partial discharge sensors in addition to the aforementioned sensors for monitoring voltage, current, temperature and vibration. However, the insulation medium acts to attenuate the PD signals, therefore weakening the damaging PD signals and making them difficult to identify. The attenuated PD signals can also be masked by sources of electrical noise.

Once PD damage has occurred, evidence of insulation deterioration can be detected by traditional methods of measuring resistance, such as megger testing. Thus, partial discharge on-line testing is complementary to traditional insulation resistance testing, allowing for the detection of progressive phases of deterioration of insulation, with trending identifying problems long before eventual failure.

A number of factors can cause detectible partial discharge, with not every factor endangering the high voltage insulation. For example, a corona into air from outdoor cable sealing ends is relatively benign. Internal PD occurs when there are voids within the coil. The interior surfaces of the voids are deteriorated by a steady bombardment of electrons and disassociated ions from the gaseous medium. Usually many years will pass before internal PD results in a failure, in contrast, slot PD occurs due to the capacitive current flowing through the coil insulation to the core of the motor. If the coil side loses contact with the core, a very high voltage develops between the two, causing PD. Slot discharges involve higher voltage levels than internal PD and can destroy the groundwall insulation if they continue over an extended period of time. Endwinding PD occurs at the endwinding of the stator, as contamination from oil films or moisture cause electrical tracking and associated PD on the insulation surface. Thus, it is important to properly classify the detected partial discharge, so as to determine whether the motor is in good condition or whether it needs attention. This classification also helps maintenance personnel identify the particular type of motor failure. For example, slot PD can be associated with voids in the insulation or thermal aging, while endwinding PD is often associated with bar vibration or dust contamination.

Historically, PD was classified by expert technicians who manually reviewed a graphical recording of the PD. More recently, various pattern recognition techniques have been employed to separate PD from noise and to classify different PD sources. While PD classification using artificial intelligence techniques has produced good results in the laboratory, field visual inspection results have not yielded comparable accuracy.

FIG. 1 is an exaggerated representation of one complete cycle of a measurement of the voltage of a motor. As FIG. 1 shows, partial discharges occur during the first and third quarters of a cycle, i.e., during the initial rising positive signal and the initial rising negative signal. These partial discharges, measured as a high frequency change in the voltage signal in millivolts to a few volts, cannot be observed with a standard scope, and are exaggerated in FIG. 1 only for purposes of illustration.

The magnitude of a partial discharge pulse also contains useful data, as a greater magnitude pulse leads to a greater amount of damage to the insulation. The pulse repetition rate indicates the number of discharges occurring, which also play a role in determining the condition of the insulation being tested.

It has also been found that a few types of PD can be classified if the magnitude of the positive polarity discharges differs from the magnitude of the negative polarity discharge. For example, if the negative polarity discharges exceed the positive polarity charges, then the probable root cause is a void between the copper conductor and insulation. Conversely, if the positive polarity discharges exceed the negative polarity discharges, then the probable root cause is either a slot discharge (caused by voids between the insulation and iron core), or a surface partial discharge, or a discharge at the winding end turns.

A number of techniques have been used to detect PD. IEC 60270 states that PDs are often accompanied by an emission of sound, light, heat, or chemical reaction. Accordingly, different measuring techniques have been used to recognize such emissions.

Once PD has been detected, it must be classified. As noted earlier, this has traditionally been done by having an expert examine a graphical recording of PD, but automatic techniques have also been developed. One useful method is to apply a multilayer artificial neural network. The basic advantage of the artificial neural network is that it can learn from examples, in which the network is presented with PD feature vectors corresponding to known defects/sources. Several different types of artificial neural networks have been used in PD recognition, including back-propagation neural net, Kohonen self-organizing feature map, learning vector quantization network, counter propagation neural net, and modular and cascaded neural nets.

In addition to many different types of artificial neural networks being available, each network has various parameters that affect performance, including the training time (epochs), the number of layers, training function, adaption function, performance function and transfer function. Thus, each neural network, trained with a given set of data and configured in a particular way, offers unique performance.

Any new rapid, direct method to help better classify on-site PD measurements will save users substantial expense, effort and time. Therefore, a need exists for an improved system and method for classify PD based on measured characteristics and/or properties.

### SUMMARY OF THE INVENTION

The above objects and further advantages are provided by the present invention which broadly comprehends a method for classifying partial discharge of high voltage motors and generators by the training of an artificial neural network application. The Applicant has found that collecting online data from a large number of motors with different PD characteristics and training an artificial neural network with the data can be used to achieve excellent results.

Importantly, this information can be obtained relatively rapidly and inexpensively compared to the prior art method of having an expert examine a graphical representation of PD waveforms of motor characteristics.

In the method of the current invention, online PD data will be collected from a large number of motors and recorded, statistical data will be extracted from each recording and used to train an artificial neural network. The method of the invention will enable users to classify PD without performing the customary extensive and time-consuming expert analysis.

### BRIEF DESCRIPTION OF THE DRAWING

Further advantages and features of the present invention will become apparent from the following detailed description of the invention when considered with reference to the figures on the accompanying drawings, in which:

FIG. 1 shows an exaggerated representation of one complete cycle of a measurement of the voltage of a motor;

FIG. 2 shows the steps of an embodiment of the method of the invention;

FIG. 3 shows a motor with a number of sensor options;

FIG. 4 is a graphical representation of phase resolved PD (“PRPD”) spectra;

FIG. 5 is a graphical representation of a reduced PRPD set;

FIG. 6 is a schematic block diagram of modules of an embodiment of the invention; and

FIG. 7 is a block diagram of a computer system in which an embodiment of the invention is implemented.

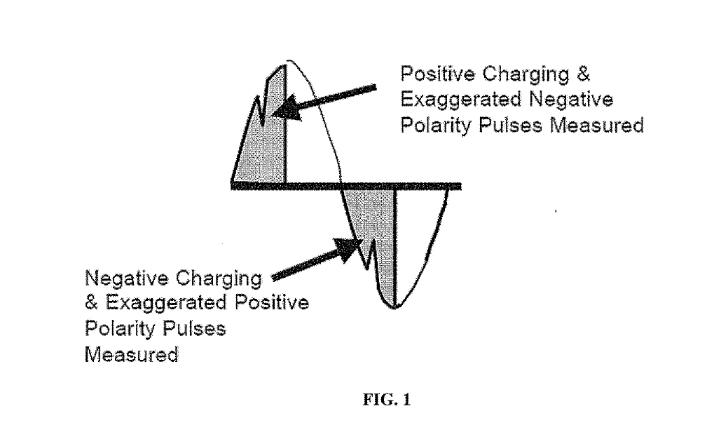

### DETAILED DESCRIPTION OF INVENTION

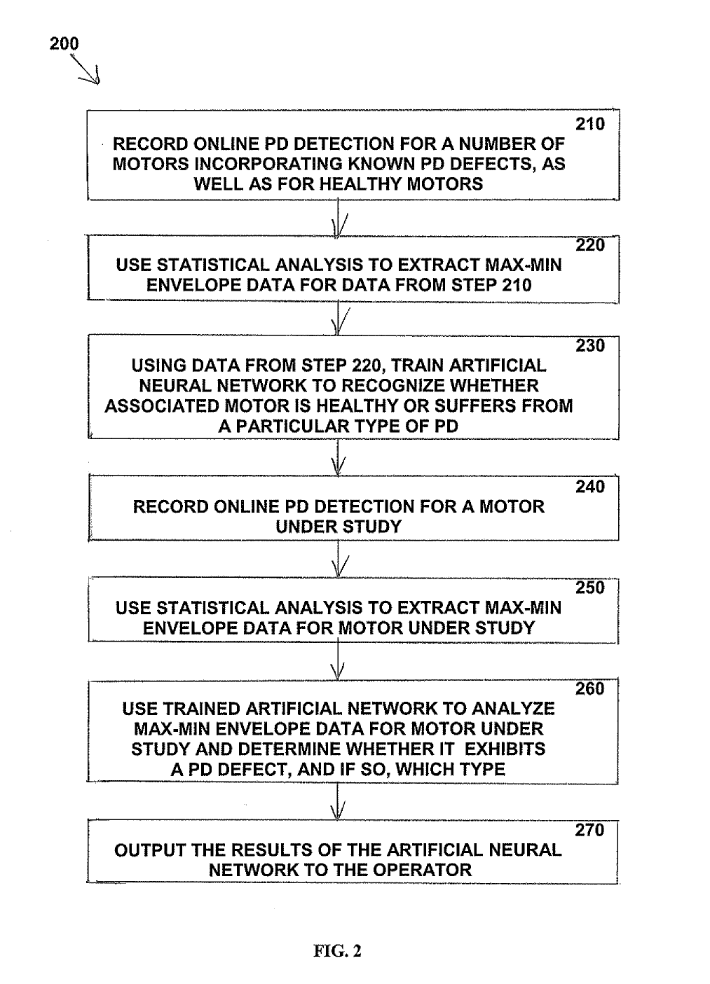

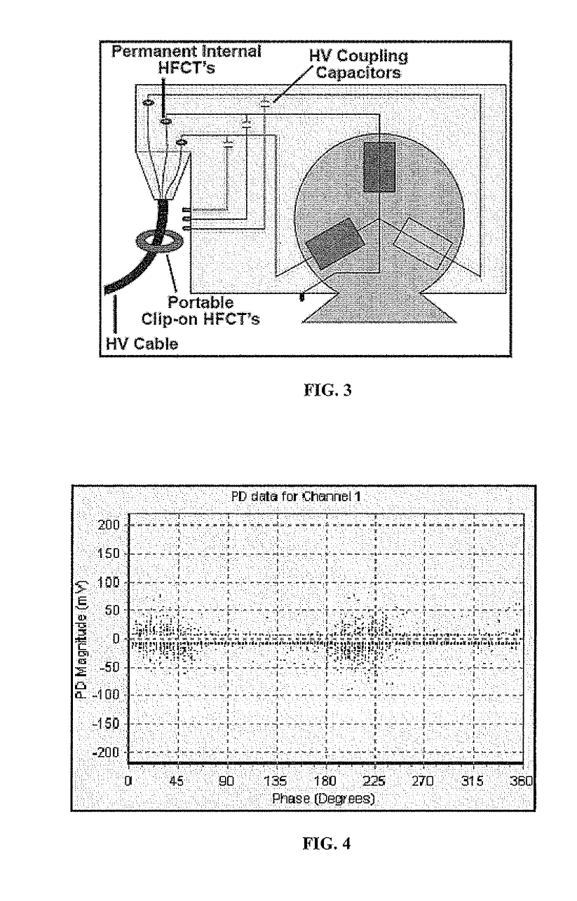

As shown in FIG. 2, the method 200 begins with step 210, in which online PD detection is recorded for a number of motors known to incorporate each type of PD defect: internal PD, corona PD, slot PD, endwinding PD, and surface PD. In addition, online PD detection is recorded for a number of motors known to be healthy. Preferably, the analysis includes at least 50 motors of each type, representing a total of 300 motors. As shown in FIG. 3, a number of sensor options are available for detecting PD, including high voltage coupling capacitors, permanent internal high frequency coupling capacitors (“HPCTs”), or portable clip-on HFCTs. In a preferred alternate embodiment, Rogowski coils are substituted for the HPCTs. A Rogowski coil is a helical coil of wire wrapped around a straight conductor whose current is to be measured, with the lead from one end of the Rogowski coil returned through the center of the coil to the other end, so that both terminals are at the same end of the coil. The Rogowski coil, having an air core, has a low inductance and can therefore respond to fast-changing currents. It is largely immune to electromagnetic interference, and it is highly linear, with the induced voltage being proportional to the rate of change (i.e., the derivative) of the current being measured. The output of the Rogowski coil is connected to an electrical or electronic integrator circuit to provide an output signal that is proportional to the current.

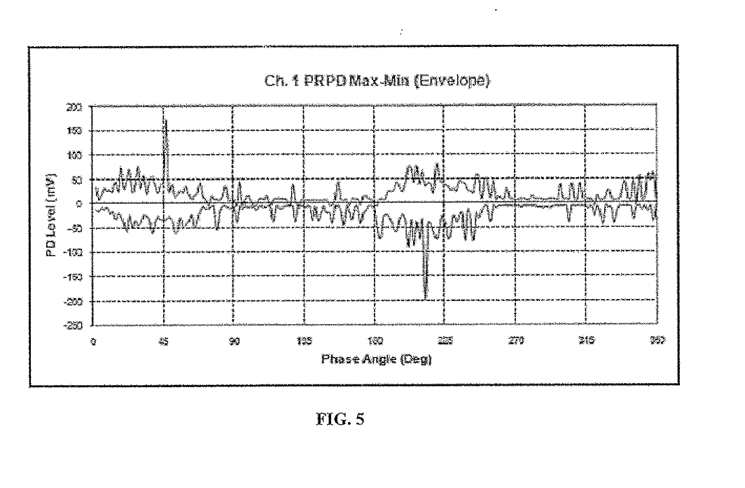

A phase resolved acquisition system and spectrum analyzer are used to record the online PD signals from the Rogowski coils. FIG. 4 shows a graphical representation of phase resolved PD (“PRPD”) spectra, seen as thousands of points. FIG. 5 shows a reduced PRPD spectra, using a max-min envelope. The method of the invention can be adapted to the processing capabilities of the computing equipment running the neural network software, by reducing the size of the PRPD spectra as necessary.

Continuing with the embodiment of the method shown in FIG. 2, in step 220, statistical analysis is used to extract max-min envelope data.

In step 230, the extracted data from step 220 is used to train an artificial neural network to recognize whether the associated motors are healthy or suffer from one of the five types of PD. Good results were obtained from NeuralSight, an artificial neural network software program produced by the company NeuralWare.

In step 240, online PD detection is performed for a motor under study.

In step 250, statistical analysis is used to extract max-min envelope data.

In step 260, the artificial neural network determines, based upon its training, whether the motor under study is healthy, or whether it suffers from internal PD, corona PD, slot PD, endwinding PD, or surface PD.

In step 270, the neural network outputs the results to the operator.

The training of the neural network in steps 210 through 230 can be conducted by one user, and the utilization of the trained network to test a motor, as detailed in steps 240 through 270, can be conducted by a second user.

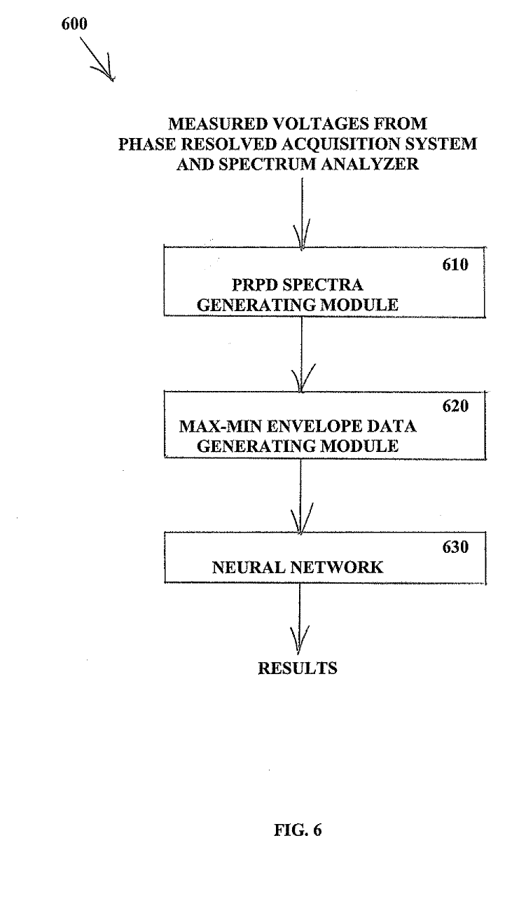

FIG. 6 illustrates a schematic block diagram of modules in accordance with an embodiment of the present invention, system 600.

PRPD spectra generating module 610 accepts measured voltages from a phase resolved acquisition system and spectrum analyzer that has subjected a high voltage motor to online PD analysis, the module processing and storing the measured voltages as a phase-resolved PD (“PRPD”) spectra.

Max-min envelope data generating module 620 receives the PRPD spectra for the high voltage motor from PRPD spectra generating module 610 and reduces it into max-min envelope data.

Neural network module 630 incorporates an artificial neural network that has previously been trained with reduced max-min envelope data from a number of motors that suffer from internal PD, corona PD, slot PD, endwinding PD, or surface PD, as well as a number of healthy motors, such that the artificial neural network is able to correctly identify the PD defect, if any, associated with reduced max-min envelope data. Neural network module 630 receives the reduced max-min envelope data from max-min envelope data generating module 620, analyzes the reduced max-min envelope data and reports the results to a user, optionally storing the results to the memory.

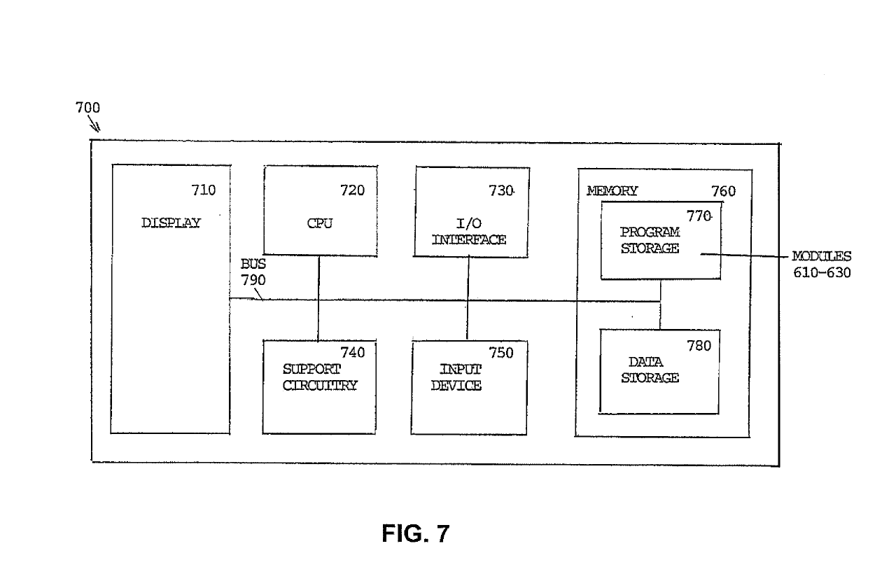

FIG. 7 shows an exemplary block diagram of a computer system 700 in which the partial discharge classification system of the present invention can be implemented. Computer system 700 includes a processor 720, such as a central processing unit, an input/output interface 730 and support circuitry 740. In certain embodiments, where the computer system 700 requires a direct human interface, a display 710 and an input device 750 such as a keyboard, mouse or pointer are also provided. The display 710, input device 750, processor 720, and support circuitry 740 are shown connected to a bus 790 which also connects to a memory 760. Memory 760 includes program storage memory 770 and data storage memory 780. Note that while computer system 700 is depicted with direct human interface components display 710 and input device 750, programming of modules and exportation of data can alternatively be accomplished over the input/output interface 730, for instance, where the computer system 700 is connected to a network and the programming and display operations occur on another associated computer, or via a detachable input device as is known with respect to interfacing programmable logic controllers.

Program storage memory 770 and data storage memory 780 can each comprise volatile (RAM) and non-volatile (ROM) memory units and can also comprise hard disk and backup storage capacity, and both program storage memory 770 and data storage memory 780 can be embodied in a single memory device or separated in plural memory devices. Program storage memory 770 stores software program modules and associated data, and in particular stores a PRPD spectra generating module 610, max-min envelope data generating module 620, and a neutral network module 630. Data storage memory 780 stores PRPD spectra data, max-min envelope data, results generated by the neural network module 630, and other data generated by the one or more modules of the present invention.

It is to be appreciated that the computer system 700 can be any computer such as a personal computer, minicomputer, workstation, mainframe, a dedicated controller such as a programmable logic controller, or a combination thereof. While the computer system 700 is shown, for illustration purposes, as a single computer unit, the system can comprise a group of computers which can be scaled depending on the processing load and database size.

Computer system 700 preferably supports an operating system, for example stored in program storage memory 770 and executed by the processor 720 from volatile memory. According to an embodiment of the invention, the operating system contains instructions for interfacing computer system 700 to the Internet and/or to private networks.

One of ordinary skill in the art will also comprehend that an embodiment of the partial discharge classification method of the present invention can be provided in the form of a computer program product.

The system and method of the present invention have been described above and with reference to the attached figure; however, modifications will be apparent to those of ordinary skill in the art and the scope of protection for the invention is to be defined by the claims that follow.

I claim:

1. A method for training an artificial neural network to characterize a high voltage motor as either healthy or as suffering from internal partial discharge (“PD”), corona PD, slot PD, endwinding PD, or surface PD, the method comprising:
identifying a number of motors that suffer from internal PD, corona PD, slot PD, endwinding PD, or surface PD, as well as a number of healthy motors;
subjecting each of the identified motors to online PD analysis, measuring PD voltage at the motor leads;
using a phase resolved acquisition system and spectrum analyzer, recording the measured voltages from each motor as a phase-resolved PD (“PRPD”) spectra;
reducing each PRPD spectra into max-min envelope data;
and training the artificial neural network with the reduced max-min envelope data from each motor, until the artificial neural network is able to correctly identify the PD defect, if any, associated with each reduced PRPD spectra.

2. A method for operating an artificial neural network to characterize a high voltage motor as either healthy or as suffering from internal partial discharge (“PD”), corona PD, slot PD, endwinding PD, or surface PD, the method comprising:
identifying a high voltage motor to be tested with a previously trained artificial network;
subjecting the identified high voltage motor to online PD analysis, measuring PD voltage at the motor leads;
using a phase resolved acquisition system and spectrum analyzer, recording the measured voltages from the high voltage motor as a phase-resolved PD (“PRPD”) spectra;
reducing the PRPD spectra for the high voltage motor into max-min envelope data;
entering the reduced max-min envelope data from the high voltage motor into the trained artificial neural network and instructing it to analyze the new data; and
reporting the results to a user.

3. A method for training and operating an artificial neural network to characterize a high voltage motor as either healthy or as suffering from internal partial discharge (“PD”), corona PD, slot PD, endwinding PD, or surface PD, the method comprising:
the method for training an artificial neural network of claim 1;
identifying a high voltage motor to be tested with a previously trained artificial network;
subjecting the identified high voltage motor to be tested to online PD analysis, measuring PD voltage at the motor leads;
using a phase resolved acquisition system and spectrum analyzer, recording the measured voltages from the high voltage motor as a phase-resolved PD (“PRPD”) spectra;
reducing the PRPD spectra for the high voltage motor into max-min envelope data;
entering the reduced max-min envelope data from the high voltage motor into the trained artificial neural network and instructing it to analyze the new data; and
reporting the results to a user.

4. The method of claim 2, further comprising recording the reported results into memory.

5. The method of claim 3, further comprising recording the reported results into memory.

6. The method of claim 1, further comprising selecting the size of the PRPD spectra to match the processing capabilities of the neural network.

7. The method of claim 2, further comprising selecting the size of the PRPD spectra to match the processing capabilities of the neural network.

8. The method of claim 3, further comprising selecting the size of the PRPD spectra to match the processing capabilities of the neural network.

9. The method of claim 1, further comprising obtaining the PD measurements at the motor leads by using Rogowski coils.

10. The method of claim 2, further comprising obtaining the PD measurements at the motor leads by using Rogowski coils.

11. The method of claim 3, further comprising obtaining the PD measurements at the motor leads by using Rogowski coils.

12. A system for characterizing a high voltage motor as either healthy or as suffering from internal partial discharge (“PD”), corona PD, slot PD, endwinding PD, or surface PD, comprising:
a non-volatile memory device that stores calculation modules and data;
a processor coupled to the memory;
a first calculation module that accepts measured voltages from a phase resolved acquisition system and spectrum analyzer that has subjected the high voltage motor to online PD analysis, the first calculation module processing and storing the measured voltages as a phase-resolved PD (“PRPD”) spectra;
a second calculation module that reduces the PRPD spectra for the high voltage motor into max-min envelope data; and
a third calculation module that incorporates an artificial neural network that has been trained with reduced max-min envelope data from a number of motors that suffer from internal PD, corona PD, slot PD, endwinding PD, or surface PD, as well as a number of healthy motors, such that the artificial neural network is able to correctly identify the PD defect, if any, associated with reduced max-min envelope data;
wherein the third calculation module receives the reduced max-min envelope data from the second calculation module, analyzes the reduced max-min envelope data and stores the results to the memory.

13. A computer program product to characterize a high voltage motor as either healthy or as suffering from internal partial discharge (“PD”), corona PD, slot PD, endwinding PD, or surface PD, comprising a non-transitory computer readable medium having computer readable program code embodied therein that, when executed by a processor, causes the processor to:
load an artificial neural network that has been trained with reduced max-min envelope data from a number of motors that suffer from internal PD, corona PD, slot PD, endwinding PD, or surface PD, as well as a number of healthy motors, with which training the artificial neural network is able to correctly identify the PD defect, if any, associated with reduced max-min envelope data;
accept voltage measurement input from a phase resolved acquisition system and spectrum analyzer that has been used to subject the high voltage motor to online PD analysis, using PD measurements at the motor leads;
store the measured voltages from the high voltage motor as a phase-resolved PD (“PRPD”) spectra;
reduce the PRPD spectra for the high voltage motor into max-min envelope data;
instruct the trained artificial neural network to analyze the reduced max-min envelope data from the high voltage motor; and
store the results from the trained artificial neural network.

14. The computer program product of claim 13, further comprising computer readable program code that, when executed by the processor, causes the processor to select the size of the PRPD spectra to match the processing capabilities of the processor.
